(19) United States
(12) Patent Application Publication
(10) Pub. No.: US 2026/0195566 A1
(43) Pub. Date: Jul. 9, 2026

(54) NOISE-RESISTANT COMMUNICATION METHOD AND APPARATUS BASED ON FULLY CONNECTED NEURAL NETWORK

(71) Applicant: Guangzhou Maritime University, Guangzhou (CN)

(72) Inventors: Jingxian Liu, Guangzhou (CN); Zhilin Mei, Guangzhou (CN); Yingqi Zhao, Guangzhou (CN); Hao Zhao, Guangzhou (CN); Jing Ling, Guangzhou (CN)

(21) Appl. No.: 19/433,045

(22) Filed: Dec. 25, 2025

(30) Foreign Application Priority Data
Jan. 3, 2025 (CN) 202510011009.0

(51) Int. Cl. G06N 3/0455

(52) U.S. Cl. CPC G06N 3/0455

(57) ABSTRACT

The present application relates to a noise-resistant communication method and apparatus based on a fully connected neural network. The method includes: encoding, before signal transmission, target information based on encoding sequences to obtain and transmit a target signal, and receiving, upon signal transmission, the target signal, and decoding the target signal via a fully connected neural network to obtain the target information, where the fully connected network takes the target signal as input and the target information as output, and a hidden layer of the fully connected neural network includes a plurality of fully connected layers for decoding. The method decodes a transmitted signal affected by noise interference via the neural network, so that a problem of an increased bit error rate caused by strong noise interference in the transmitted signal is effectively avoided.

### CROSS REFERENCE TO RELATED APPLICATIONS

The present application claims the benefit of Chinese Patent Application No. 202510011009.0 filed on Jan. 3, 2025, the contents of which are incorporated herein by reference in their entirety.

### FIELD OF TECHNOLOGY

The present application relates to the technical field of wireless communication, in particular to a noise-resistant communication method and apparatus based on a fully connected neural network.

### BACKGROUND

In current communication systems, filtering technology, modulation and demodulation technology, and spread spectrum technology can all counteract noise interference to a certain extent. The spread spectrum technology demonstrates stronger noise resistance under conventional white noise interference, and therefore has been more widely applied.

The spread spectrum technology utilizes the correlation of communication signals to perform correlation operations on a received noisy spread spectrum signal with a local known reference signal, thereby suppressing uncorrelated noise. However, when the received noise is relatively large, the transmission signal subjected to spread spectrum will be submerged by the noise, resulting in an increased bit error rate.

### SUMMARY

To solve the above problems in the prior art, the purpose of the present application is to provide a noise-resistant communication method and apparatus based on a fully connected neural network.

In a first aspect, the present application provides a noise-resistant communication method based on a fully connected neural network. The method includes:
encoding, before signal transmission, target information based on encoding sequences to obtain and transmit a target signal, wherein the encoding sequences include different sequences of equal length, and the encoding sequences are in one-to-one correspondence with each type of symbol in the target information; and
receiving, upon signal transmission, the target signal, and decoding the target signal through a fully connected neural network to obtain the target information, wherein the fully connected network takes the target signal as input and the target information as output, and a hidden layer of the fully connected neural network includes a plurality of fully connected layers for decoding.

In one embodiment, the length of the encoding sequences is set according to the number of input nodes of the fully connected neural network, and the step of encoding the target information based on the encoding sequences includes:
performing an encoding operation on each symbol in the target information sequentially according to the encoding sequence to obtain a symbol encoding column vector corresponding to each symbol and having the same length as the encoding sequence; and
horizontally combining the symbol encoding column vectors according to a symbol order in the target information to form an encoding matrix as the target signal.

In one embodiment, the encoding operation includes using an encoding sequence corresponding to each symbol as the symbol encoding column vector corresponding to the symbol; and the encoding sequence includes several discrete sine wave sequences with different frequencies and initial phases.

In one embodiment, the step of receiving the target signal and decoding the target signal through the fully connected neural network to obtain the target information includes:
obtaining a decoding matrix by enabling the target signal to pass through the plurality of fully connected layers, wherein column vectors of the decoding matrix are single-valued decoding vectors;
classifying the column vectors of the decoding matrix according to a classification function to obtain a prediction matrix; and
performing a determining operation on a predicted value of each column vector of the prediction matrix sequentially to obtain the target information, wherein the determining operation includes using a symbol corresponding to a threshold range of the predicted value as an output symbol of the column vector.

In one embodiment, the symbols include a first symbol and a second symbol having different values; the encoding sequences include a discrete first sine wave sequence corresponding to the first symbol and a discrete second sine wave sequence corresponding to the second symbol; and the first sine wave sequence and the second sine wave sequence differ in frequency and initial phase.

In one embodiment, the classification function is a sigmoid function; and a threshold range corresponding to the first symbol is less than 0.5, and a threshold range corresponding to the second symbol is not less than 0.5.

In one embodiment, a noise-affected encoding matrix subjected to preset noise interference is used as the training set for training the fully connected neural network; the noise-affected encoding matrix includes symbol encoding column vectors of random signals.

In a second aspect, the present application provides a noise-resistant communication apparatus based on a fully connected neural network. The apparatus includes:
an encoding module, configured to encode, before signal transmission, target information based on encoding sequences to obtain and transmit a target signal, wherein the encoding sequences include several different sequences of equal length, and the encoding sequences are in one-to-one correspondence with each type of symbol in the target information; and
a decoding module, configured to receive, upon signal transmission, the target signal, and decode the target signal through a fully connected neural network to obtain the target information, wherein the fully connected network takes the target signal as input and the target information as output, and a hidden layer of the fully connected neural network includes a plurality of fully connected layers for decoding.

In a third aspect, the present application provides a computer device. The computer device includes a memory and a processor, wherein the memory stores a computer program, and the processor, when executing the computer program, implements the steps of the method according to any one of the first aspect of the present application.

In a fourth aspect, the present application further provides a computer-readable storage medium storing a computer program, wherein the computer program, when executed by a processor, implements the steps of the method according to any one of the first aspect of the present application.

According to the noise-resistant communication method based on the fully connected neural network provided by the present application, each symbol in the target information is encoded into encoded information in the target signal with a wider spectrum and being regular, which can improve the spectrum utilization and noise resistance of the target signal; upon receiving the target signal, feature extraction is performed on the target signal using the pre-trained fully connected neural network, and signals close to the encoded information can be identified under noise interference, so that corresponding symbols are obtained, and the noise-affected target signal is decoded into the target information; and a weight of the hidden layer of the pre-trained fully connected neural network is optimized using noise-affected signals from a training set, so that similar encoding sequences are identified from the noise-affected signals, and a problem of an increased bit error rate caused by strong noise interference in transmitted signals is effectively avoided.

### BRIEF DESCRIPTION OF THE DRAWINGS

To more clearly illustrate the technical solutions of the embodiments of the present application or the prior art, the drawings required for the description of the embodiments or the prior art will be briefly introduced below. Apparently, the drawings described below are merely some embodiments of the present application. Those ordinarily skilled in the art can obtain other drawings based on these drawings without creative effort.

FIG. 1 is a flowchart of the steps of a noise-resistant communication method based on a fully connected neural network according to one embodiment.

FIG. 2 is a flowchart of the steps of encoding target information into a target signal based on an encoding sequence according to one embodiment.

FIG. 3 is a flowchart of the steps of decoding a target signal into target information via a fully connected neural network according to one embodiment.

FIG. 4 is a schematic diagram of nodes in each layer of a hidden layer of an initial fully connected neural network according to one embodiment.

FIG. 5 is a comparison chart of bit error rates after noise interference between a method provided by the present application and a pseudo-random correlation identification method in a case where a length of an encoding sequence is 80 discrete points according to one embodiment.

FIG. 6 is a comparison chart of bit error rates after noise interference between a method provided by the present application and a pseudo-random correlation identification method in a case where a length of an encoding sequence is 40 discrete points according to one embodiment.

FIG. 7 is a structural block diagram of a noise-resistant communication apparatus based on a fully connected neural network according to one embodiment.

### DESCRIPTION OF THE EMBODIMENTS

For ease of understanding, the present application will be described more comprehensively below with reference to the relevant drawings. The drawings illustrate embodiments of the present application. However, the present application may be implemented in many different forms and is not limited to the embodiments described herein. On the contrary, the provision of these embodiments is intended to make the disclosure of the present application more thorough and comprehensive.

Unless otherwise defined, all technical and scientific terms used herein have the same meaning as commonly understood by those skilled in the art to which the present application belongs. The terminology used in the specification of the present application is intended only for the purpose of describing specific embodiments and is not intended to limit the present application.

As used herein, the singular forms “a,” “an,” and “the” may also include plural forms unless the context clearly indicates otherwise. It should also be understood that the terms “comprise/include,” “have,” and the like specify the presence of stated features, elements, steps, operations, components, parts, or combinations thereof, but do not preclude the presence or addition of one or more other features, elements, steps, operations, components, parts, or combinations thereof. Meanwhile, the term “and/or” as used in this specification includes any and all combinations of the listed items.

Furthermore, the terms “first” and “second” are used merely for descriptive purposes and should not be construed as indicating or suggesting relative importance or implying the number of the indicated technical features. Thus, features defined as “first” or “second” may explicitly or implicitly include at least one such feature. In the description of the present application, “a plurality of” means at least two, for example, two and three, unless otherwise specifically defined.

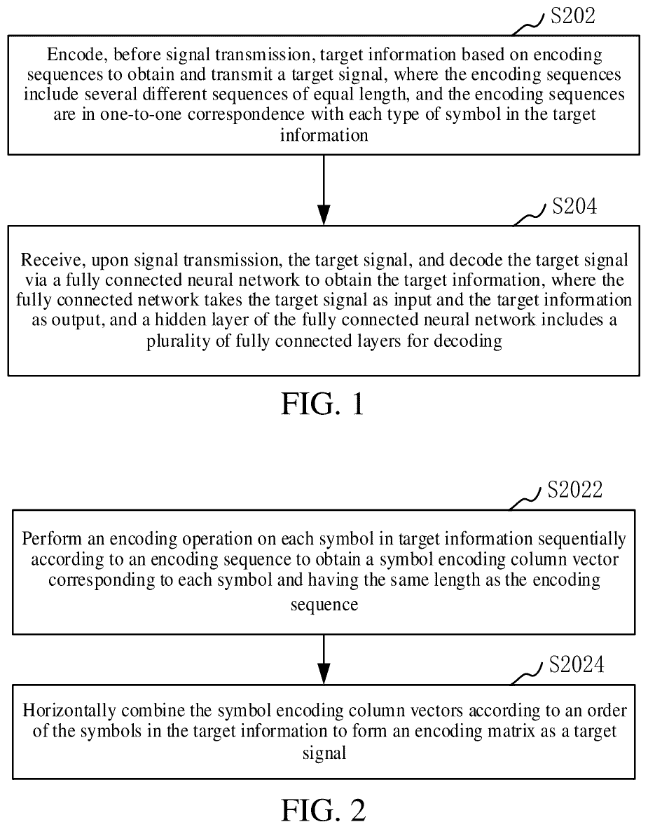

A noise-resistant communication method based on a fully connected neural network provided by the present application, as shown in FIG. 1, includes the following steps S202 and S204.

In S202, before signal transmission, target information is encoded based on encoding sequences to obtain and transmit a target signal. The encoding sequences include several different sequences of equal length, and the encoding sequences are in one-to-one correspondence with each type of symbol in the target information.

In the encoding of a set of target information, the encoding sequences include a plurality of amplitude sequences of a consistent length and regularity, which may be various waveform sampling sequences with differences in a time domain or waveform sampling sequences with differences in a frequency domain. The possible number of symbols in the set of target information is equal to the number of the encoding sequences, that is, the encoding sequences are in one-to-one correspondence with each type of symbol in the set of target information.

Specifically, before signal transmission, an encoding module uses the encoding sequences to encode the symbols of the target information, so as to obtain and transmit the target signal including an encoding result of all the symbols in the target information. The encoding process may include: directly using the encoding sequences as encoding output of the symbols or combining the encoding sequences with the symbols via a correlation function to obtain the encoding output.

In S204, upon signal transmission, the target signal is received and decoded via a fully connected neural network to obtain the target information. The fully connected network takes the target signal as input and the target information as output. A hidden layer of the fully connected neural network includes a plurality of fully connected layers for decoding.

Specifically, upon signal transmission, a receiving module receives a target signal affected by noise during transmission, and then inputs the noise-affected target signal into a pre-trained fully connected neural network as a decoder to obtain decoded target information. The decoding process includes: identifying, by the fully connected neural network, noise-affected waveforms in the target signal that are similar to certain encoding sequence waveforms through the plurality of fully connected layers in the hidden layer, so as to obtain a prediction matrix for the noise-affected target signal, and then obtaining the output target information based on the prediction matrix.

According to the noise-resistant communication method based on the fully connected neural network provided by the present application, each symbol in the target information is encoded into encoded information in the target signal with a wider spectrum and being regular, which can improve the spectrum utilization and noise resistance of the target signal; upon receiving the target signal, feature extraction is performed on the target signal using the pre-trained fully connected neural network, and signals close to the encoded information can be identified under noise interference, so that corresponding symbols are obtained, and the noise-affected target signal is decoded into the target information; and a weight of the hidden layer of the pre-trained fully connected neural network is optimized using noise-affected signals from a training set, so that similar encoding sequences are identified from the noise-affected signals, and a problem of an increased bit error rate caused by strong noise interference in transmitted signals is effectively avoided.

In an exemplary embodiment, the length of the encoding sequences is set according to the number of input nodes of the fully connected neural network. As shown in FIG. 2, encoding the target information based on the encoding sequences includes the following steps S2022 and S2024.

In S2022, an encoding operation is performed on each symbol in the target information sequentially according to the encoding sequences to obtain a symbol encoding column vector corresponding to each symbol and having the same length as the encoding sequences.

Specifically, the encoding operation is performed on each symbol in the target information using the preset corresponding encoding sequence according to an order of the symbols in the target information, so as to obtain symbol codes to be stored in column vector format. The length of the symbol encoding column vector is set to be equal to that of the encoding sequences, so that the format of the target signal can match an input format of the fully connected neural network.

Preferably, the encoding operation includes using the encoding sequence corresponding to each symbol as the symbol encoding column vector corresponding to the symbol. For several sine wave signals with different frequencies and initial phases, a plurality of different discrete sine wave sequences are obtained as encoding sequences by sampling based on a preset sampling interval and duration. The number of discrete points in an encoding sequence is the length of the encoding sequence.

In S2024, the symbol encoding column vectors are horizontally combined according to the order of the symbols in the target information to form an encoding matrix as the target signal.

Specifically, the symbol encoding column vectors are horizontally combined according to the order of the symbols to form the encoding matrix, which is the target signal. The number of rows in the encoding matrix is equal to the length of the symbol encoding column vectors, and the number of columns in the encoding matrix is equal to the number of the symbols in the target information.

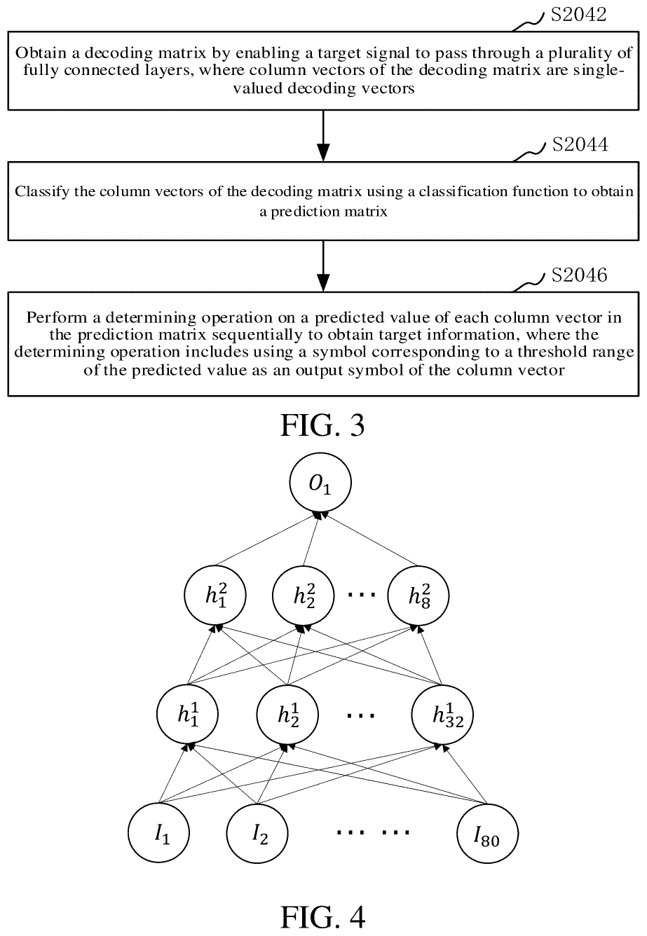

In an exemplary embodiment, as shown in FIG. 3, receiving the target signal and decoding the target signal via the fully connected neural network to obtain the target information includes the following steps S2042 to S2046.

In S2042, a decoding matrix is obtained by enabling the target signal to pass through the plurality of fully connected layers. Column vectors of the decoding matrix are single-valued decoding vectors.

Specifically, upon signal transmission, the target signal affected by noise during transmission is received and decoded via the fully connected neural network. In the fully connected neural network, the decoding matrix is obtained by left-multiplying weight matrices of the fully connected layers in the hidden layer by the target signal for calculations. A column vector of the decoding matrix is a single-valued decoding vector, which represents a feature value of a column in the target signal. The number of rows in the decoding matrix is one.

In S2044, the column vectors of the decoding matrix are classified according to a classification function to obtain a prediction matrix.

Specifically, the fully connected neural network further includes a fully connected layer including a classification function. The classification function obtains a predicted value of each column in the decoding matrix according to a feature value of the column, where the predicted value is used to distinguish a symbol corresponding to the column.

In S2046, a determining operation is performed on a predicted value of each column vector of the prediction matrix sequentially to obtain the target information. The determining operation includes using a symbol corresponding to a threshold range of the predicted value as an output symbol of the column vector.

Specifically, according to the threshold range of the predicted value of each column, the symbol corresponding to each column vector is sequentially determined, and finally, a row vector with a length equal to the number of characters in the target information is obtained, where the row vector is the decoded target information. The number of the threshold ranges matches the possible number of the symbols in the target information.

It should be understood that although the steps in the flowcharts of FIG. 1 to FIG. 3 are shown sequentially according to the direction of the arrows, these steps are not necessarily executed in the order indicated by the arrows. Unless explicitly stated otherwise herein, the execution of these steps is not strictly limited to a particular order, and the steps may be performed in other sequences. Moreover, at least some of the steps in FIG. 1 to FIG. 3 may include a plurality of steps or stages, which do not necessarily need to be completed at the same time, but may be executed at different times. The execution order of these steps or stages is not necessarily sequential. Instead, they can be executed alternately or concurrently with other steps or at least part of the steps or stages in other steps.

To further illustrate the solution of the present application, a specific example is described below. A noise-resistant communication method based on a fully connected neural network provided by the present application includes the following steps 1 to 4.

In step 1, target information to be transmitted is obtained as 10011, denoted as s_{1,5}. A preset encoding sequence in an encoding module corresponding to a symbol 1 is a sine wave sequence with a frequency of 0.2π, an initial phase of 0π, a sampling interval of 0.1 s and 80 discrete points, i.e., s₁(n)=sin (0.2π·0.1·n), where n denotes the serial number of a discrete point, ranging from 0 to 79. An encoding sequence corresponding to a symbol 0 is a sine wave sequence with a frequency of 0.4π, an initial phase of 0.5π, a sampling interval of 0.1 s and 80 discrete points, i.e., s₀ (n)=sin (0.4π·0.1·n+0.5π), where n denotes the serial number of a discrete point, ranging from 0 to 79. The target information s_{1,5} is encoded using the preset encoding sequence to obtain the encoded target signal as a matrix

$${I}_{80 , 5} = [ {s}_{1}^{T} , {s}_{0}^{T} , {s}_{0}^{T} , {s}_{1}^{T} , {s}_{1}^{T} ] ,$$

where T indicates sequence transposition.

In step 2, the received target signal IN_{80,5}, which is interfered by noise during transmission, is input into a pre-trained fully connected neural network for computation. A hidden layer of the fully connected neural network has three fully connected layers. A weight matrix of a first fully connected layer is W_{32,80}, a weight matrix of a second fully connected layer is W_{8,32}, a weight matrix of a third fully connected layer is W_{1,8}. Thus, a decoding matrix O_{1,5} output by the hidden layer is obtained by the following formula:

$${O}_{1 , 5} = {W}_{1 , 8} \cdot ReLU ( {W}_{8 , 32} \cdot ReLU ( {W}_{32 , 80} \cdot {IN}_{80 , 5} ) )$$

where ReLU is an activation function.

In step 3, an output layer of the fully connected neural network calculates a prediction matrix \tilde{s}_{1,5}=[0.85,0.23,0.15,0.92,0.96] based on the decoding matrix. A calculation formula is as follows:

$${\tilde{s}}_{1 , 5} = sigmoid ( {O}_{1 , 5} )$$

where sigmoid is a classification function.

In step 4, a predicted value of each column in the prediction matrix \tilde{s}_{1,5} is determined. If the predicted value of a column is not less than 0.5, the column is determined to correspond to the symbol 1. If the predicted value of a column is less than 0.5, the column is determined to correspond to the symbol 0. Therefore, the target information correspondingly output by the prediction matrix \tilde{s}_{1,5} is 10011, which matches the target information to be transmitted.

In a specific embodiment, a method for training the fully connected neural network includes the following steps a and b.

In step a, 100 symbols with values of 0 or 1 are randomly generated, denoted as s_{1,100}. The 100 symbols are encoded in order to obtain an encoding matrix I_{80,100}, and a sine wave amplitude of an encoding sequence is set to 1. White noise is added to the encoded sequence to obtain a noise-affected encoding matrix IN_{80,100}, where a mean of the white noise is 0 and a deviation is 3.

In step b, the number of nodes in each layer of a hidden layer of an initial fully connected neural network is as shown in FIG. 4, where I₁ to I₈₀ are input nodes of the first fully connected layer;

$${h}_{1}^{1} to {h}_{32}^{1}$$

are output nodes of the first fully connected layer, i.e., input nodes of the second fully connected layer;

$${h}_{1}^{2} to {h}_{8}^{2}$$

are output nodes of the second fully connected layer, i.e., input nodes of the third fully connected layer; and O₁ is an output node of the third fully connected layer.

During the process of training the initial fully connected neural network model using the noise-affected encoding matrix, a binary cross-entropy loss function BCEWithLogitsLoss is used. The formula is as follows:

$$L = BCEWithLogitsLoss ( {O}_{1 , 100} , {s}_{1 , 100} )$$

where L denotes a difference between an output value and an expected value; and stochastic gradient descent is used to optimize the weight matrix W^{32×80} of the first fully connected layer, the weight matrix W^{8×32} of the second fully connected layer, and the weight matrix W^{1x8} of the third fully connected layer. The pre-trained fully connected neural network is obtained by repeating the training 2000 times.

To verify the noise resistance performance of the above noise-resistant communication method based on the fully connected neural network, the following comparative experiment was conducted in this embodiment:

a sine wave with a frequency of 0.2π, a phase of 0π and a time interval of 0.1 s and a sine wave with a frequency of 0.4π, a phase of 0.5π and a time interval of 0.1 s were selected to generate two encoding sequences with lengths of 80 and 40, respectively, so as to encode a symbol 1 and a symbol 0 in a test signal, respectively. Correspondingly, the spread spectrum encoding technology uses classic m-sequences as a spread spectrum pseudo-random sequence to perform spread spectrum encoding on the symbol 1 and the symbol 0 in the test signal, with sequence lengths also being 80 and 40, respectively. The m-sequences are generated by a primitive polynomial y=x⁶+x+1. The symbol 0 is encoded using any m-sequence, and the symbol 1 is encoded using a complement of the m-sequence. For fair comparison, an average encoding distance of the sine wave encoding sequences used in this method is specified to be the same as an average encoding distance of the m-sequence and the complement thereof.

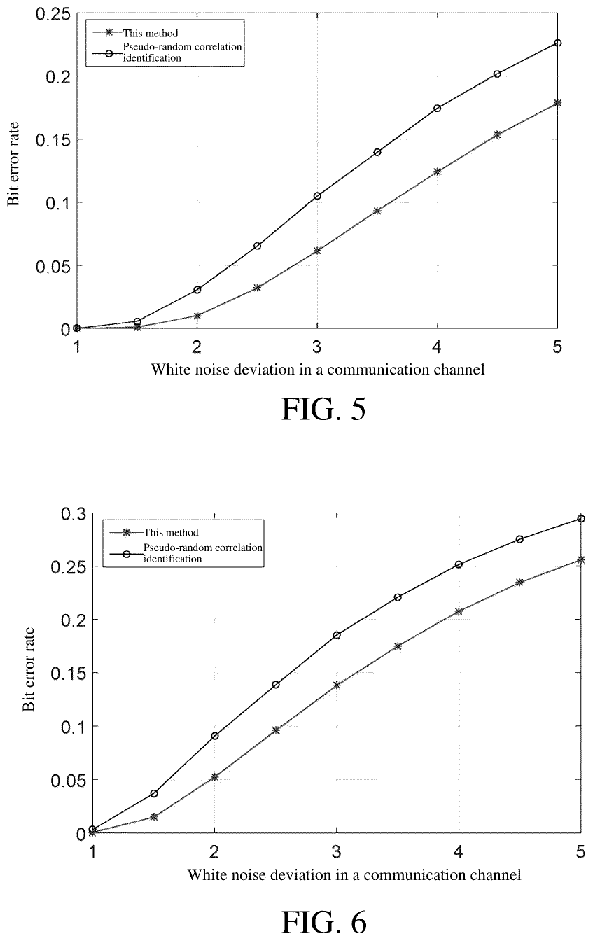

In a case where the lengths of the sine wave sequences and the m-sequence are 80 discrete points, bit error rates of this method and a pseudo-random correlation identification method under white noise interference with a deviation from 1 to 5 are obtained, as shown in FIG. 5. In a case where the lengths of the sine wave sequences and the m-sequence are 40 discrete points, the bit error rates of this method and the pseudo-random correlation identification method under white noise interference with the deviation from 1 to 5 are obtained, as shown in FIG. 6.

Analysis of FIG. 5 and FIG. 6 shows that regardless of whether the length of the encoding sequences used is 80 or 40, the bit error rate of this method is significantly lower than that of the pseudo-random correlation identification method. This proves that the noise-resistant communication method based on the fully connected neural network provided by the present application has excellent noise resistance performance.

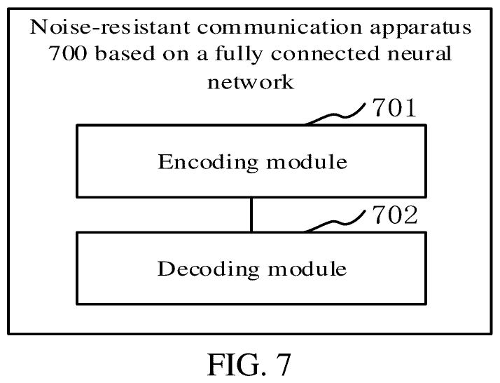

In a second aspect, as shown in FIG. 7, the present application provides a noise-resistant communication apparatus 700 based on a fully connected neural network. The apparatus includes:
an encoding module 701, configured to encode, before signal transmission, target information based on encoding sequences to obtain and transmit a target signal, where the encoding sequences include several different sequences of equal length, and the encoding sequences are in one-to-one correspondence with each type of symbol in the target information; and
a decoding module 702, configured to receive, upon signal transmission, the target signal, and decode the target signal via a fully connected neural network to obtain the target information, where the fully connected network takes the target signal as input and the target information as output, and a hidden layer of the fully connected neural network includes a plurality of fully connected layers for decoding.

The specific limitations of the noise-resistant communication apparatus based on the fully connected neural network can be referred to in the above limitations of the noise-resistant communication method based on the fully connected neural network, which will not be repeated here. Each module in the above noise-resistant communication apparatus based on the fully connected neural network may be implemented entirely or partially by software, hardware, or a combination thereof. The above modules may be embedded in or independent of a processor of a computer device in hardware form, or stored in a memory of the computer device in software form, so that the processor can call and execute the operations corresponding to each module described above. It should be noted that the division of modules in the embodiments of the present application is illustrative and represents only one logical functional division; other division methods may be adopted in actual implementation.

In a third aspect, the present application provides a computer device. The computer device includes a memory and a processor, where the memory stores a computer program, and the processor executes the computer program to implement the steps of any noise-resistant communication method based on the fully connected neural network provided by the present application.

In a fourth aspect, the present application further provides a computer-readable storage medium storing a computer program. The computer program, when executed by a processor, implements the steps of any noise-resistant communication method based on the fully connected neural network provided by the present application.

It will be understood by those ordinarily skilled in the art that all or part of the processes in the above method embodiments may be performed by instructing relevant hardware via a computer program. The computer program may be stored in a non-volatile computer-readable storage medium, and when executed, may include the processes of the method embodiments described above. Any reference to a memory, a database, or other media used in the embodiments provided in the present application may include at least one of a non-volatile memory or a volatile memory. The non-volatile memory may include a read-only memory (ROM), a magnetic tape, a floppy disk, a flash memory, an optical storage, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external high-speed cache, and the like. By way of illustration and not limitation, the RAM may be in various forms, such as a static random access memory (SRAM) or a dynamic random access memory (DRAM). The database involved in the embodiments provided by the present application may include at least one of a relational database or a non-relational database. The non-relational database may include a distributed database based on a blockchain, without limitation. The processor involved in the embodiments provided by the present application may be a general-purpose processor, a central processing unit, a graphics processor, a digital signal processor, a programmable logic device, a data processing logic based on quantum computing, and the like, without limitation.

The technical features of the above embodiments may be combined in any manner. For brevity, not all possible combinations of the technical features in the above embodiments are described. However, as long as the combination of these technical features is not contradictory, it should be considered within the scope described in this specification.

The above embodiments only express several implementations of the present application, and their descriptions are specific and detailed, but should not be construed as limiting the scope of the patent of the present application. It should be noted that for those ordinarily skilled in the art, various modifications and improvements may be made without departing from the spirit of the present application, and these all fall within the scope of protection of the present application. Therefore, the scope of protection of the present application shall be determined by the appended claims.

What is claimed is:

1. A noise-resistant communication method based on a fully connected neural network, comprising:
encoding, before signal transmission, target information based on encoding sequences to obtain and transmit a target signal, wherein the encoding sequences comprise several different sequences of equal length, and the encoding sequences are in one-to-one correspondence with each type of symbol in the target information; and
receiving, upon signal transmission, the target signal, and decoding the target signal via a fully connected neural network to obtain the target information, wherein the fully connected network takes the target signal as input and the target information as output, and a hidden layer of the fully connected neural network comprises a plurality of fully connected layers for decoding.

2. The method according to claim 1, wherein the length of the encoding sequences is set according to the number of input nodes of the fully connected neural network, and the step of encoding the target information based on the encoding sequences comprises:
performing an encoding operation on each symbol in the target information sequentially according to the encoding sequence to obtain a symbol encoding column vector corresponding to each symbol and having the same length as the encoding sequence; and
horizontally combining the symbol encoding column vectors according to a symbol order in the target information to form an encoding matrix as the target signal.

3. The method according to claim 2, wherein the encoding operation comprises using an encoding sequence corresponding to each symbol as the symbol encoding column vector corresponding to the symbol; and the encoding sequence comprises several discrete sine wave sequences with different frequencies and initial phases.

4. The method according to claim 2, wherein the step of receiving the target signal and decoding the target signal through the fully connected neural network to obtain the target information comprises:
obtaining a decoding matrix by enabling the target signal to pass through the plurality of fully connected layers, wherein column vectors of the decoding matrix are single-valued decoding vectors;
classifying the column vectors of the decoding matrix according to a classification function to obtain a prediction matrix; and
performing a determining operation on a predicted value of each column vector of the prediction matrix sequentially to obtain the target information, wherein the determining operation comprises using a symbol corresponding to a threshold range of the predicted value as an output symbol of the column vector.

5. The method according to claim 4, wherein the symbols comprise a first symbol and a second symbol having different values; the encoding sequences comprise a discrete first sine wave sequence corresponding to the first symbol and a discrete second sine wave sequence corresponding to the second symbol; and the first sine wave sequence and the second sine wave sequence differ in frequency and initial phase.

6. The method according to claim 5, wherein the classification function is a sigmoid function; a threshold range corresponding to the first symbol is less than 0.5, and a threshold range corresponding to the second symbol is not less than 0.5.

7. The method according to claim 1, wherein a noise-affected encoding matrix subjected to preset noise interference is used as a training set for training the fully connected neural network; and the noise-affected encoding matrix comprises symbol encoding column vectors of random signals.

8. A noise-resistant communication apparatus based on a fully connected neural network, comprising:
an encoding module, configured to encode, before signal transmission, target information based on encoding sequences to obtain and transmit a target signal, wherein the encoding sequences comprise several different sequences of equal length, and the encoding sequences are in one-to-one correspondence with each type of symbol in the target information; and
a decoding module, configured to receive, upon signal transmission, the target signal, and decode the target signal through a fully connected neural network to obtain the target information, wherein the fully connected network takes the target signal as input and the target information as output, and a hidden layer of the fully connected neural network comprises a plurality of fully connected layers for decoding.

9. A computer device, comprising a memory and a processor, wherein the memory stores a computer program, and the processor, when executing the computer program, implements the steps of the method according to claim 1.

10. A computer device, comprising a memory and a processor, wherein the memory stores a computer program, and the processor, when executing the computer program, implements the steps of the method according to claim 2.

11. A computer device, comprising a memory and a processor, wherein the memory stores a computer program, and the processor, when executing the computer program, implements the steps of the method according to claim 3.

12. A computer device, comprising a memory and a processor, wherein the memory stores a computer program, and the processor, when executing the computer program, implements the steps of the method according to claim 4.

13. A computer device, comprising a memory and a processor, wherein the memory stores a computer program, and the processor, when executing the computer program, implements the steps of the method according to claim 5.

14. A computer device, comprising a memory and a processor, wherein the memory stores a computer program, and the processor, when executing the computer program, implements the steps of the method according to claim 6.

15. A computer-readable storage medium storing a computer program, wherein the computer program, when executed by a processor, implements the steps of the method according to claim 1.

16. A computer-readable storage medium storing a computer program, wherein the computer program, when executed by a processor, implements the steps of the method according to claim 2.

17. A computer-readable storage medium storing a computer program, wherein the computer program, when executed by a processor, implements the steps of the method according to claim 3.

18. A computer-readable storage medium storing a computer program, wherein the computer program, when executed by a processor, implements the steps of the method according to claim 4.

19. A computer-readable storage medium storing a computer program, wherein the computer program, when executed by a processor, implements the steps of the method according to claim 5.

20. A computer-readable storage medium storing a computer program, wherein the computer program, when executed by a processor, implements the steps of the method according to claim 6.
